(19) United States
(12) Patent Application Publication
(10) Pub. No.: US 2017/0171278 A1
(43) Pub. Date: Jun. 15, 2017

(54) METHOD AND ELECTRONIC DEVICE FOR CONTINUOUSLY PLAYING VIDEO

(71) Applicants: LE HOLDINGS (BEIJING) CO., LTD., Beijing (CN); LE SHI INTERNET INFORMATION & TECHNOLOGY CORP, BEIJING, Beijing (CN)

(72) Inventors: Kaixuan YANG, Beijing (CN); Zhen LI, Beijing (CN)

(21) Appl. No.: 15/241,987

(22) Filed: Aug. 19, 2016

Related U.S. Application Data
(63) Continuation of application No. PCT/CN2016/089229, filed on Jul. 7, 2016.

(30) Foreign Application Priority Data
Dec. 14, 2015 (CN) 201510924938.7

(51) Int. Cl. H04L 29/06; H04N 21/44

(52) U.S. Cl. CPC H04L 65/604; H04L 65/80; H04N 21/44004

(57) ABSTRACT

The present disclosure relates to a method and electronic device for continuously playing video. The method includes: obtaining a total duration and a current playing duration of a video when the video in a video list is being played, determining a next target video to be played in the video list when a difference between the total duration and the current playing duration is less than a first threshold value, downloading the target video in the video list, and playing a downloaded part in the target video when the video is ended or an instruction for playing the target video is received. If the difference between the total duration and the current playing duration of the video is less than the first threshold value when the video in the video list is being played, it means that the video is about to be ended, and a next target video to be played in the video list may be firstly determined, and then be started to be downloaded, so that a downloaded part in the target video can be directly played when the video is ended or an instruction for playing the target video is received.

### CROSS REFERENCE TO RELATED APPLICATION

This application is a continuation of International PCT Patent Application No. PCT/CN2016/089229, filed Jul. 7, 2016 (attached hereto as an Appendix), and claims benefit/priority of Chinese patent application No. 201510924938.7, filed with the State Intellectual Property Office of China on Dec. 14, 2015, which are all incorporated herein by reference in entirety.

### TECHNOLOGY FIELD

The present disclosure relates to the field of communication technology, and in particular, to a method and electronic device for continuously playing video.

### BACKGROUND

At present, with a development of internet technology, it is gradually becoming a customary action for a user to watch videos on a video website or video software.

When watching videos on the video website or video software, the user may continuously watch a plurality of videos correlated with each other. To meet the user's viewing demand, operators may place videos correlated with each other in a video list on video website or video software in advance, so that after the user finishes watching one video in the video list, the video website or video software will automatically play a next video in the video list, so as to realize a continuous playing of videos correlated with each other.

For example, when watching a TV play A on a video website, the user will firstly find out a video list corresponding to the TV play A on the video website, and then will select one video from the video list to be watched. After the video is ended, the video website will automatically play a next video in the video list.

Although a continuous playing of videos correlated with each other can be realized in the above method, if a download speed of a network used by the user is lower when the video website or video software automatically plays a next video in the video list, it is required to take a long time to buffer before the video website or video software starts to play the next video in the video list, so that this method may waste user's precious time, thereby lowering user's viewing experience.

### SUMMARY

The present disclosure provides a method and electronic device for continuously playing video, which directly plays a target video after video switching, so as to save a latency time for video switching.

In a first aspect, embodiments of the present disclosure provide a method for continuously playing video, including:

obtaining a total duration and a current playing duration of a video when the video in a video list is being played;
determining a next target video to be played in the video list when a difference between the total duration and the current playing duration is less than a first threshold value;
downloading the target video in the video list; and
playing a downloaded part in the target video when the video is ended or an instruction for playing the target video is received.

In a second aspect, embodiments of the present disclosure provide a non-volatile computer storage medium stored with computer executable instructions, which are used to perform any one of the above methods for continuously playing video of the present disclosure.

In a third aspect, embodiments of the present disclosure further provide an electronic device, including one or more processors and a memory storing instructions executable by the one or more processors, wherein the instructions are set to perform any one of the above methods for continuously playing video of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart illustrating a method for continuously playing video provided according to an embodiment of the present disclosure.

FIG. 2 is a flowchart illustrating another method for continuously playing video provided according to an embodiment of the present disclosure.

FIG. 3 is a flowchart illustrating yet another method for continuously playing video provided according to an embodiment of the present disclosure.

FIG. 4 is a flowchart illustrating yet another method for continuously playing video provided according to an embodiment of the present disclosure.

FIG. 5 is a flowchart illustrating yet another method for continuously playing video provided according to an embodiment of the present disclosure.

FIG. 6 is a schematic diagram illustrating a device for continuously playing video provided according to an embodiment of the present disclosure.

FIG. 7 is a schematic diagram illustrating another device for continuously playing video provided according to an embodiment of the present disclosure.

FIG. 8 is a schematic diagram illustrating yet another device for continuously playing video provided according to an embodiment of the present disclosure.

FIG. 9 is a schematic diagram illustrating yet another device for continuously playing video provided according to an embodiment of the present disclosure.

FIG. 10 is a schematic diagram illustrating yet another device for continuously playing video provided according to an embodiment of the present disclosure.

FIG. 11 is a structure diagram of an electronic device according to an embodiment of the present disclosure.

### DETAILED DESCRIPTION

The technical solutions in embodiments of the present disclosure will be described clearly and fully below in conjunction with the drawings in the embodiments of the present disclosure. Apparently, the embodiments described are only a part of the embodiments of the present disclosure, rather than being all of the embodiments. All of the other embodiments obtained by one of ordinary skilled in the art based on the embodiments of the present disclosure without creative work pertain to the protection scope of the present disclosure.

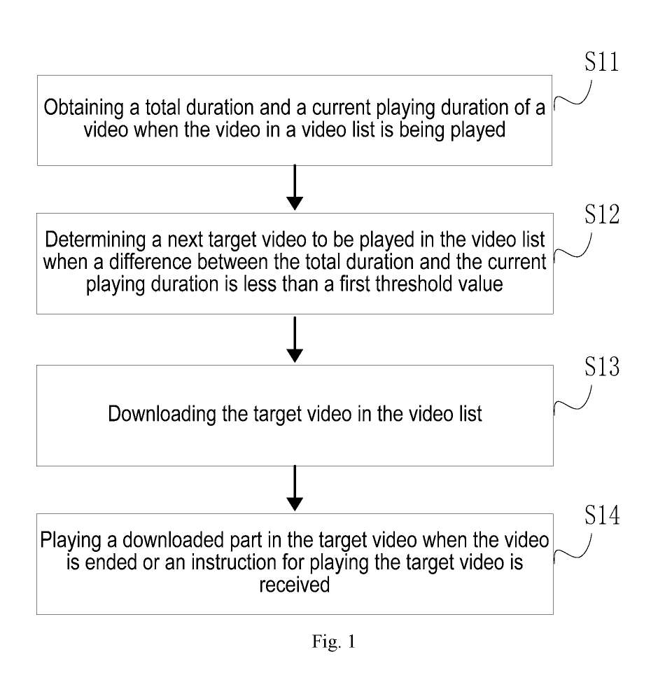

FIG. 1 is a flowchart illustrating a method for continuously playing video provided according to an embodiment of the present disclosure. As shown in FIG. 1, the method for continuously playing video shown in FIG. 1 may be applied to a terminal. The method for continuously playing video provided by the present disclosure may shorten user's latency time during video switching, thereby improving user's viewing experience. The method includes the following steps.

In step S11, a total duration and a current playing duration of a video is obtained when the video in a video list is being played.

The method provided by the present disclosure may be applied to a terminal capable of playing videos, and the terminal may be equipment such as smart mobile phone, tablet computer, laptop computer or desktop computer and the like.

The video list includes a plurality of videos correlated with each other. For example, a TV play A includes 30 videos in total, and an operator may arrange the 30 videos of the TV play A in a video list X in advance, so that the user may rapidly find out each of the videos of the TV play A in the video list X.

The total duration of a video refers to a time duration for playing the video. For example, a total duration of a video is 120 minutes.

The current playing duration of a video refers to a time duration during which the video has been played. For example, a total duration of a video is 120 minutes, and the video has been played for 90 minutes up to the current time, so the current playing duration of the video is 90 minutes.

In step S11, when playing a video in the video list, the terminal will obtain a total duration and a current playing duration of the video, so that whether to download a target video in the video list is determined depending on a difference between the total duration and the current playing duration is less than a first threshold value in the subsequent steps.

Furthermore, in an optional solution of an embodiment of the present disclosure, when playing a video in the video list and before obtaining a total duration and a current playing duration of the video, the terminal may firstly judge whether the video has been downloaded completely. If so, a next target video to be played in the video list is then started to be downloaded; and if not yet, the step of obtaining a total duration and a current playing duration of the video is then executed. Where the video has been downloaded completely, the terminal may directly download the target video so as to save time, without necessarily judging whether a difference between the total duration and the current playing duration is less than a first threshold value.

In step S12, a next target video to be played in the video list is determined when a difference between the total duration and the current playing duration is less than a first threshold value.

The first threshold value refers to a preset time duration, which may be set as per actual cases. For example, the first threshold value may be preset to be 10 minutes.

After obtaining a total duration and a current playing duration of a video, the terminal will judge whether a difference between the total duration and the current playing duration is less than a first threshold value. When the terminal judges the difference between the total duration and the current playing duration is less than the first threshold value, it means that the video is about to be ended, and the terminal may then determine a next target video to be played depending on a playing sequence of the video list, so that the terminal can download the target video before the video is ended.

For example, it is assumed that the first threshold value is 20 minutes, the video list includes a first video, a second video and a third video, and a default playing sequence in the video list is the first video, the second video and the third video. At this moment when the terminal is playing the second video, the terminal will obtain a total duration and a current playing duration of the second video. Supposing that the total duration of the second video obtained by the terminal is 120 minutes, and the current playing duration of the second video obtained by the terminal is 110 minutes, the terminal will judge that a difference between the total duration and the current playing duration is less than the first threshold value. The terminal may determine the difference between the total duration of 120 minutes and the current playing duration of 110 minutes is 10 minutes, which is less than the first threshold value of 20 minutes, thus the terminal will determine the third video to be played next in the video list.

In step S13, the target video in the video list is downloaded.

After determining a next target video to be played in the video list, the terminal may download the target video in the video list.

When downloading the target video in the video list, the terminal will download the target video according to a playing time of the target video, so that when the video is ended or an instruction for playing the target video is received, the terminal may start playing video from a starting time of the target video.

For example, supposing that a total duration of a target video is 50 seconds, after determining a next target video to be played in the video list, the terminal will download the target video according to a playing time of the target video. In other words, the terminal will download the target video from the first second of the starting time of the target video to the 50^{th} second of the ending time of the target video.

In an optional solution of an embodiment of the present disclosure, after determining a next target video to be played in the video list, the terminal may judge whether to enable a function of skipping titles for a preset time. If so, the terminal may then start downloading from the preset time of the target video; and if not, the terminal may then download the target video normally.

For example, it is assumed that a total duration of a target video is 50 minutes, and a preset time is 2 minutes. After determining a next target video to be played in the video list, the terminal will judge whether to enable a function of skipping titles for the preset time of 2 minutes. When judging that the function of skipping titles for the preset time of 2 minutes has been enabled, the terminal will then start downloading from the preset time of 2 minutes of the target video.

In an optional solution of an embodiment of the present disclosure, after determining a next target video to be played in the video list, the terminal may obtain a bit stream of a video being played. Supposing that the bit stream of the video being played is A, then a target video having a bit stream A is downloaded, so as to allow the bit stream of the video being played is identical with the bit stream of the target video downloaded in advance. Certainly, if the bit stream of the video being played obtained by the terminal is A, and the highest bit stream of the target video is only B, wherein the bit stream A has a higher definition than that of the bit stream B, the terminal will then download a target video having a bit stream B.

In step S14, a downloaded part in the target video is played when the video is ended or an instruction for playing the target video is received.

After downloading a target video in the video list, the terminal will judge whether the video has been ended, and judge whether an instruction for playing the target video is received. When judging that the video is ended or that an instruction for playing the target video is received, the terminal will then start playing the downloaded part in the target video, so as to realize a continuous video playing with no latency time.

For example, it is assumed that a first threshold value is 20 minutes, a video list includes a first video and a second video, and a default playing sequence in the video list is the first video and the second video. At this moment when the terminal is playing the second video, the terminal will obtain a total duration and a current playing duration of the first video. Supposing that a total duration of the second video obtained by the terminal is 120 minutes, and a current playing duration of the second video obtained by the terminal is 110 minutes, the terminal may judge a difference between the total duration of 120 minutes and the current playing duration of 110 minutes is 10 minutes, which is less than the first threshold value of 20 minutes, thus the terminal will determine the second video to be played next in the video list. After that, the terminal will download the second video according to a playing time of the second video, in other words, the terminal will download the second video from the first second of the starting time of the second video to the 120^{th} minute of the ending time of the second video. No matter whether the second video has been downloaded completely, the terminal should play a downloaded part in the target video as long as the terminal judges the first video is ended or an instruction for playing the second video is received. At this moment, the second video has been started to be played, and if the second video is not downloaded completely yet, the terminal will then continue downloading the remained part not downloaded yet.

In the embodiment as shown in FIG. 1, if a difference between a total duration and a current playing duration of a video is less than a first threshold value when the video in a video list is being played, it means that the video is about to be ended. In this case, a next target video to be played in the video list may be firstly determined, and then be started to be downloaded, so that a downloaded part in the target video can be directly played when the video is ended or an instruction for playing the target video is received. Therefore, the solutions provided by the present disclosure may directly play a target video after video switching, so as to save a latency time for buffering the target video, thereby improving user's viewing experience.

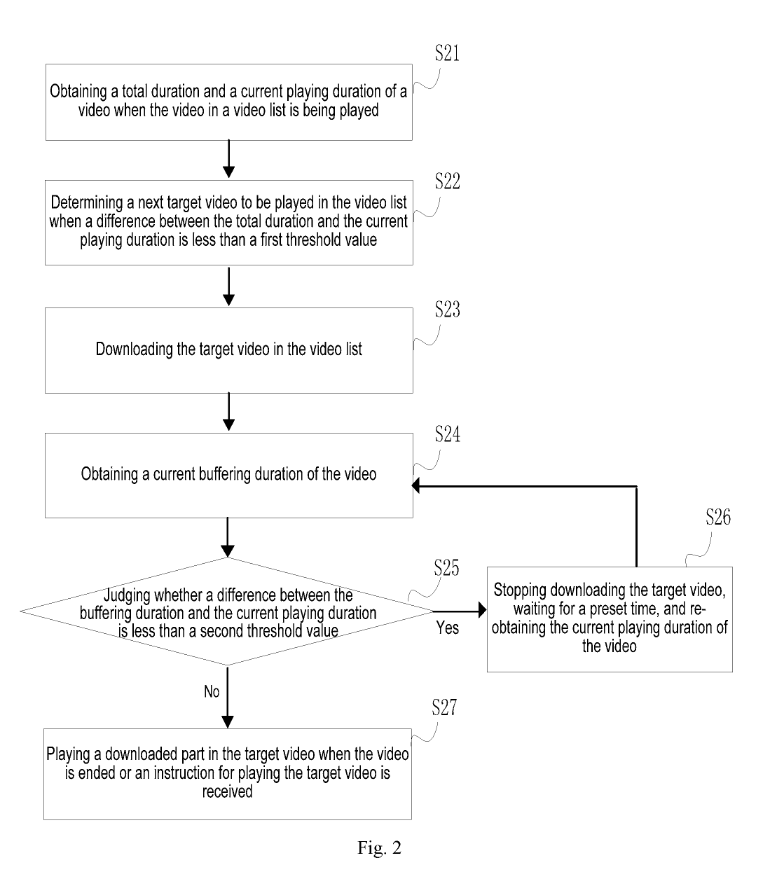

FIG. 2 is a flowchart illustrating another method for continuously playing video provided according to an embodiment of the present disclosure. FIG. 2 is an optional embodiment based on FIG. 1. In the embodiment shown in FIG. 2, a part identical with the embodiment shown in FIG. 1 may refer to the introduction and explanation in the embodiment shown in FIG. 1. The method shown in FIG. 2 includes the following steps.

In step S21, a total duration and a current playing duration of a video is obtained when the video in a video list is being played.

In step S22, a next target video to be played in the video list is determined when a difference between the total duration and the current playing duration is less than a first threshold value.

In step S23, the target video in the video list is downloaded.

In step S24, a current buffering duration of the video is obtained.

The current buffering duration of the video refers to a duration of the part of the video that has been downloaded completely and may be played.

For example, supposing that a total duration of a video is 120 minutes, a current playing duration of the video is 30 minutes, and a current buffering duration of the video is 31 minutes, it means that the first 31 minutes of the video has been downloaded completely and may be played, while the remained part of the video after the 31 minutes is not downloaded yet and cannot be played.

In step S25, whether a difference between the buffering duration and the current playing duration is less than a second threshold value is judged. When the difference between the buffering duration and the current playing duration is less than the second threshold value, step S26 is triggered; and when the difference between the buffering duration and the current playing duration is larger than or equal to the second threshold value, step S27 is triggered.

The second threshold value refers to a preset time duration, which may be set as per actual cases. For example, the first threshold value may be preset to be 10 seconds.

A preset time refers to a preset time duration, which may be set as per actual cases. For example, the preset time may be preset to be 5 seconds.

After obtaining a current buffering duration of the video, the terminal will judge whether a difference between the buffering duration and the current playing duration is less than a second threshold value. When the difference between the buffering duration and the current playing duration is less than the second threshold value, it means that a current network of the terminal has a low download speed, the terminal is not adaptive to downloading the video and a target video simultaneously, and thus the terminal needs to stop downloading the target video but downloading the video only, so as to prevent a lag from being incurred during video playing. After stopping downloading the target video, the terminal further needs to wait for a preset time, then re-obtain a current playing duration of the video, and trigger step S24 to re-judge whether the terminal is adaptive to downloading the video and a target video simultaneously.

When a difference between the buffering duration and the current playing duration is larger than or equal to the second threshold value, it means that a current network of the terminal has a high download speed, the terminal is adaptive to downloading the video and a target video simultaneously. After that, the terminal may then trigger step S24, so that the terminal may judge whether the video is ended, and judge whether an instruction for playing the target video is received.

In step S26, the target video is stopped from being downloaded, a preset time is waited, a current playing duration of the video is re-obtained, and step S24 is triggered.

In sep S27, a downloaded part in the target video is played when the video is ended or an instruction for playing the target video is received.

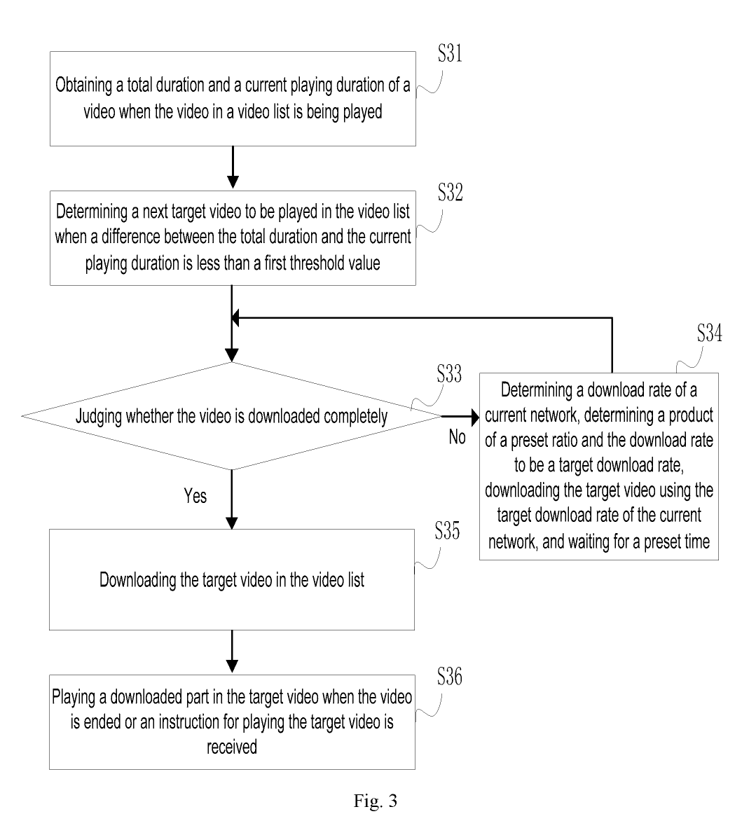

FIG. 3 is a flowchart illustrating yet another method for continuously playing video provided according to an embodiment of the present disclosure. FIG. 3 is an optional embodiment based on FIG. 1. In the embodiment shown in FIG. 3, a part identical with the embodiment shown in FIG. 1 may refer to the introduction and explanation in the embodiment shown in FIG. 1. The method shown in FIG. 3 includes the following steps.

In step S31, a total duration and a current playing duration of a video is obtained when the video in a video list is being played.

In step S32, a next target video to be played in the video list is determined when a difference between the total duration and the current playing duration is less than a first threshold value.

In step S33, whether the video is downloaded completely is judged. When the video is downloaded completely, step S35 is triggered; and when the video is not downloaded completely yet, step S34 is triggered.

After determining a next target video to be played in the video list, the terminal needs to judge whether the video is downloaded completely. When the video is downloaded completely, it means that a network of the terminal is in an idle state, and the terminal may download the target video using the network. When the video is not downloaded completely yet, it means that the terminal is downloading the video, thus the terminal may download the target video using a certain proportion of network bandwidth, and may use the remained network bandwidth to download the video. Therefore, the present embodiment may not only ensure a download speed for a video being played currently, but also attend to downloading a target video in advance.

In step S34, a download rate of a current network is determined, a product of a preset ratio and the download rate is determined to be a target download rate, the target video is downloaded using the target download rate of the current network, a preset time is waited, and step S33 is triggered.

The download rate of a current network refers to a download speed of the current network. For example, it is assumed that the terminal determines a download rate of a current network to be 1000 KB/s.

The preset ratio is a ratio set in advance, which may be set as per actual cases. For example, a preset ratio may be set to be 10%.

The preset time refers to a preset time duration, which may be set as per actual cases. For example, a preset time may be set to be 5 seconds.

For example, it is assumed that the terminal determines a download rate of a current network is 1000 KB/s, a preset ratio is 10%, and a preset time is 5 seconds. After determining the download rate of the current network is 1000 KB/s, the terminal will calculate a product of the preset ratio of 10% and the download rate of 1000 KB/s to obtain a target download rate of 100 KB/s. After that, the terminal will then download a target video using the target download rate of the current network of 100 KB/s, wait for the preset time of 5 seconds, and then judge whether the video is downloaded completely. The terminal will not download the target video using the download rate of the current network of 1000 KB/s until judging that the video has been downloaded completely.

In step S35, the target video in the video list is downloaded.

In step S36, a downloaded part in the target video is played when the video is ended or an instruction for playing the target video is received.

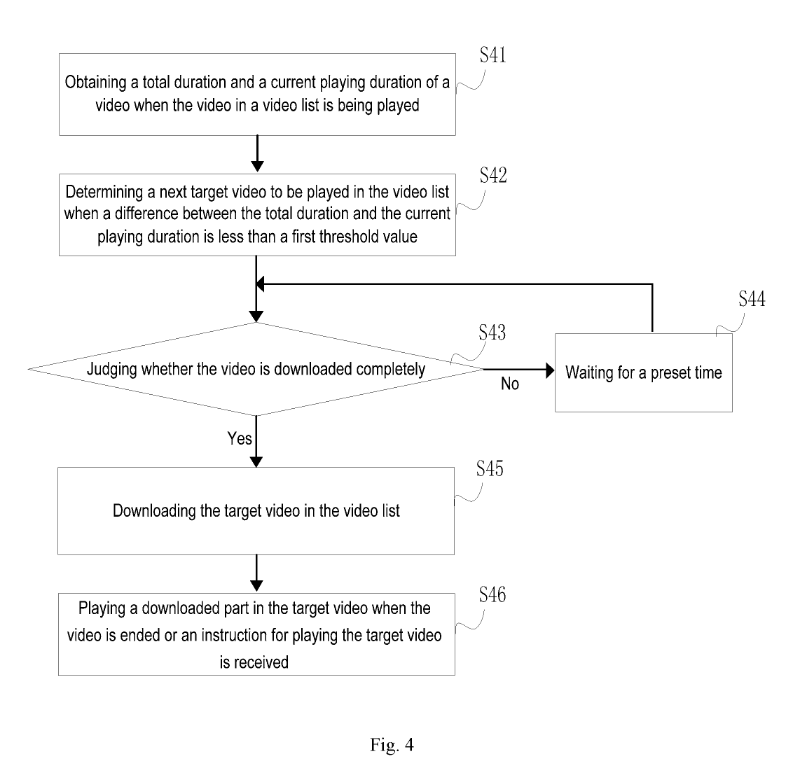

FIG. 4 is a flowchart illustrating yet another method for continuously playing video provided according to an embodiment of the present disclosure. FIG. 4 is an optional embodiment based on FIG. 1. In the embodiment shown in FIG. 4, a part identical with the embodiment shown in FIG. 1 may refer to the introduction and explanation in the embodiment shown in FIG. 1. The method shown in FIG. 4 includes the following steps.

In step S41, a total duration and a current playing duration of a video is obtained when the video in a video list is being played.

In step S42, a next target video to be played in the video list is determined when a difference between the total duration and the current playing duration is less than a first threshold value.

In step S43, whether the video is downloaded completely is judged. When the video is downloaded completely, step S45 is triggered; and when the video is not downloaded completely yet, step S44 is triggered.

After determining a next target video to be played in the video list, the terminal needs to judge whether the video is downloaded completely. When the video is downloaded completely, it means that a network of the terminal is in an idle state, and the terminal may download the target video using the network. When the video is not downloaded completely yet, it means that the terminal is downloading the video. In order to prevent a lag of video playing from being incurred by simultaneously downloading the video and the target video, the terminal will wait for a preset time, and then judge whether the video is downloaded completely. The terminal will not download the target video using the current network until judging that the video has been downloaded completely.

In step S44, a preset time is waited, and step S43 is triggered.

In step S45, the target video in the video list is downloaded.

In step S46, a downloaded part in the target video is played when the video is ended or an instruction for playing the target video is received.

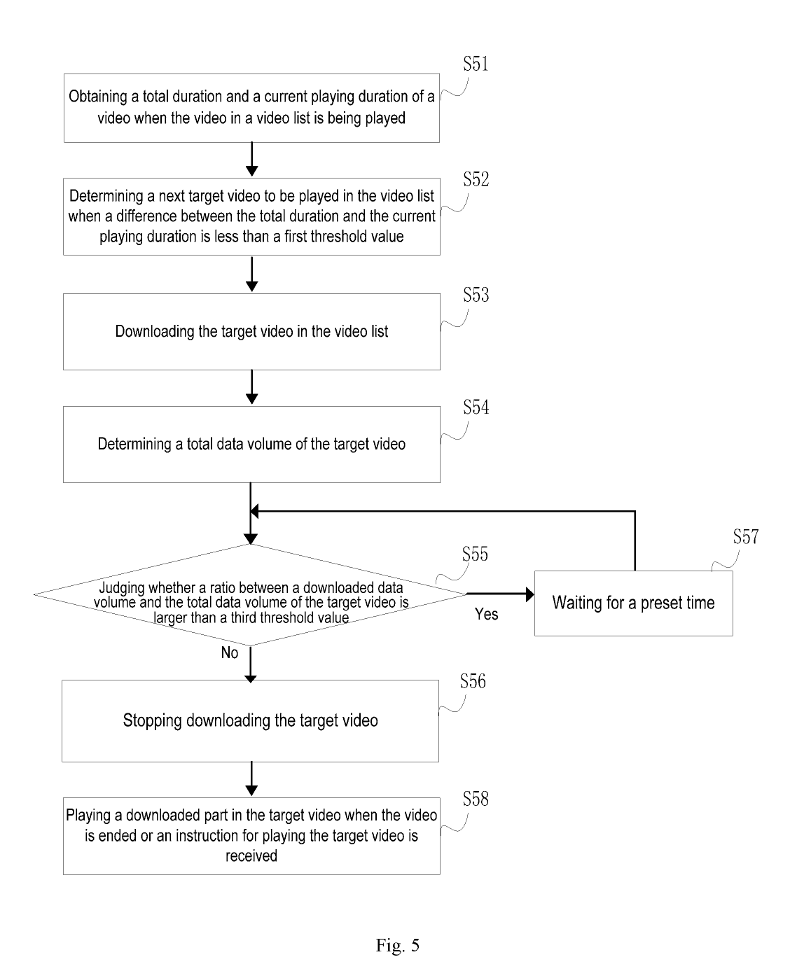

FIG. 5 is a flowchart illustrating yet another method for continuously playing video provided according to an embodiment of the present disclosure. FIG. 5 is an optional embodiment based on FIG. 1. In the embodiment shown in FIG. 5, a part identical with the embodiment shown in FIG. 1 may refer to the introduction and explanation in the embodiment shown in FIG. 1. The method shown in FIG. 5 includes the following steps.

In step S51, a total duration and a current playing duration of a video is obtained when the video in a video list is being played.

In step S52, a next target video to be played in the video list is determined when a difference between the total duration and the current playing duration is less than a first threshold value.

In step S53, the target video in the video list is downloaded.

In step S54, a total data volume of the target video is determined.

The total data volume of the target video refers to a size of the target video. For example, supposing that a target video is a movie in a size of 1 GB, the total data volume of the target video is 1 GB. For another example, supposing that a target video is a short video in a size of 100 MB, the total data volume of the target video is 100 MB.

In step S55, whether a ratio between a downloaded data volume and the total data volume of the target video is larger than a third threshold value is judged. When the ratio between the downloaded data volume and the total data volume of the target video is larger than the third threshold value, step S56 is triggered; and when the ratio between the downloaded data volume and the total data volume of the target video is less than or equal to the third threshold value, step S57 is triggered.

The third threshold value refers to a preset proportionality coefficient. For example, a third threshold value may be set to be 10%.

After determining a total data volume of the target video, the terminal will then judge whether a ratio between a downloaded data volume and the total data volume of the target video is larger than a third threshold value.

When the ratio between the downloaded data volume and the total data volume of the target video is larger than the third threshold value, it means that the terminal has downloaded a preset proportion of the target video. Thus, even if the video is ended or the terminal receives an instruction for playing the target video, it has been sufficient for the terminal to play a downloaded part in the target video. Taking into account to prevent a case where the user may not continue watching a target video after finishing watching a video being played currently, the terminal does not need to download more proportion of the target video when playing the video, so as to save network resources. Thus, when judging that the ratio between the downloaded data volume and the total data volume of the target video is larger than the third threshold value, the terminal will stop downloading the target video and trigger step S58 to wait for the end of the video or wait for receiving an instruction for playing the target video.

When the ratio between the downloaded data volume and the total data volume of the target video is less than or equal to the third threshold value, it means that the terminal has not downloaded the preset proportion of the target video yet. Thus, the terminal will wait for a preset time, so as to continue downloading the target video within this period of time, and then trigger step S55 to judge whether the ratio between the downloaded data volume and the total data volume of the target video is larger than the third threshold value. The terminal will not stop downloading the target video until judging that the ratio between the downloaded data volume and the total data volume of the target video is larger than the third threshold value.

In step S56, the target video is stopped from being downloaded, and step S58 is triggered.

In step S57, a preset time is waited, and step S55 is triggered.

In sep S58, a downloaded part in the target video is played when the video is ended or an instruction for playing the target video is received.

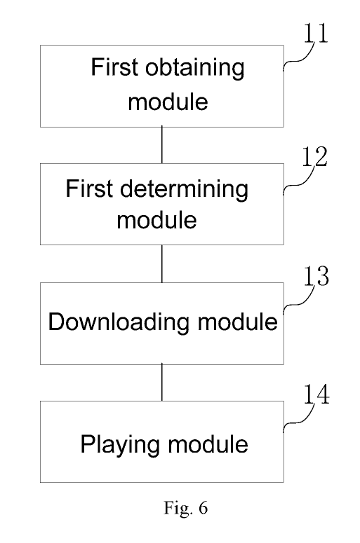

FIG. 6 is a schematic diagram illustrating a device for continuously playing video provided according to an embodiment of the present disclosure. Referring to FIG. 6, the device includes a first obtaining module 11, a first determining module 12, a downloading module 13 and a playing module 14.

The first obtaining module 11 obtains a total duration and a current playing duration of a video when the video in a video list is being played.

The first determining module 12 determines a next target video to be played in the video list when a difference between the total duration and the current playing duration is less than a first threshold value.

The downloading module 13 downloads the target video in the video list.

The playing module 14 plays a downloaded part in the target video when the video is ended or an instruction for playing the target video is received.

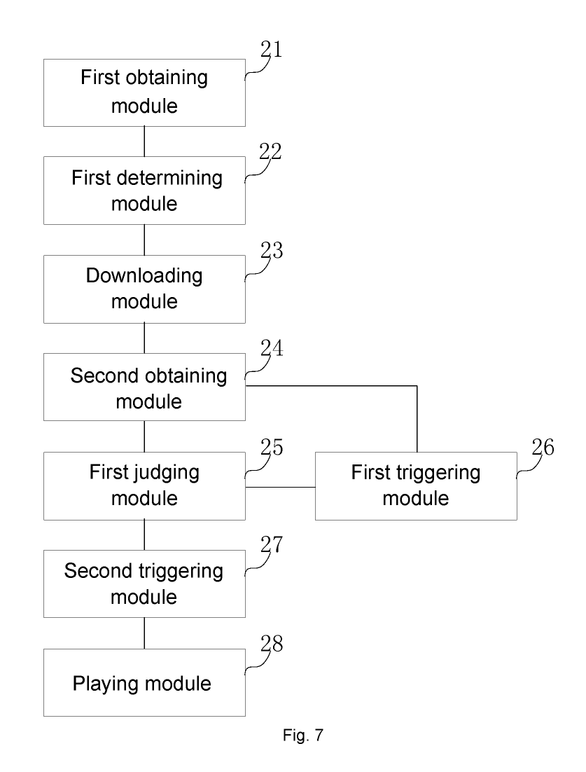

FIG. 7 is a schematic diagram illustrating another device for continuously playing video provided according to an embodiment of the present disclosure. Referring to FIG. 7, the device includes a first obtaining module 21, a first determining module 22, a downloading module 23, a second obtaining module 24, a first judging module 25, a first triggering module 26, a second triggering module 27 and a playing module 28.

The first obtaining module 21 obtains a total duration and a current playing duration of a video when the video in a video list is being played.

The first determining module 22 determines a next target video to be played in the video list when a difference between the total duration and the current playing duration is less than a first threshold value.

The downloading module 23 downloads the target video in the video list.

The second obtaining module 24 obtains a current buffering duration of the video.

The first judging module 25 judges whether a difference between a buffering duration and the current playing duration is less than a second threshold value.

The first triggering module 26 stops downloading the target video, wait for a preset time, re-obtain the current playing duration of the video, and trigger the second obtaining module 24, when the difference between the buffering duration and the current playing duration is less than the second threshold value.

The second triggering module 27 triggers the playing module 28, when the difference between the buffering duration and the current playing duration is larger than or equal to the second threshold value.

The playing module 28 plays a downloaded part in the target video when the video is ended or an instruction for playing the target video is received.

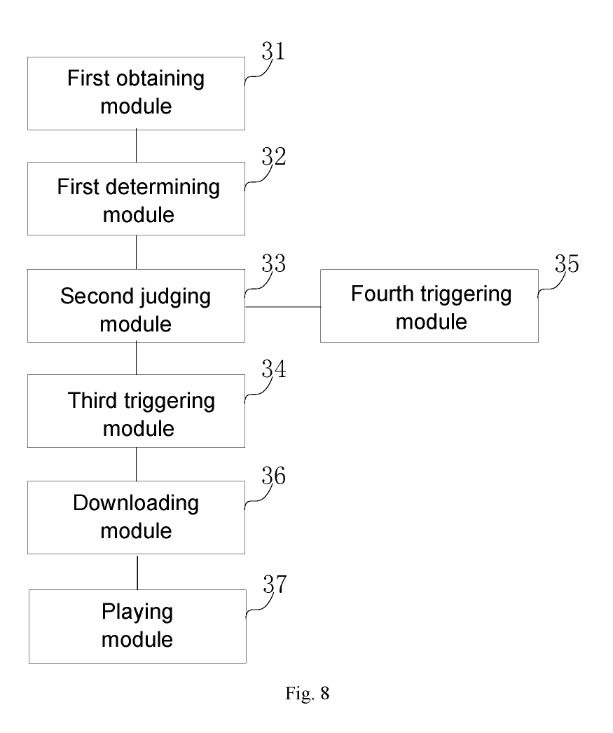

FIG. 8 is a schematic diagram illustrating yet another device for continuously playing video provided according to an embodiment of the present disclosure. Referring to FIG. 8, the device includes a first obtaining module 31, a first determining module 32, a second judging module 33, a third triggering module 34, a fourth triggering module 35, a downloading module 36 and a playing module 37.

The first obtaining module 31 obtains a total duration and a current playing duration of a video when the video in a video list is being played.

The first determining module 32 determines a next target video to be played in the video list when a difference between the total duration and the current playing duration is less than a first threshold value.

The second judging module 33 judges whether the video is downloaded completely.

The third triggering module 34 triggers the downloading module 36 when the video is downloaded completely.

The fourth triggering module 35 determines a download rate of a current network, determines a product of a preset ratio and the download rate to be a target download rate, downloads the target video using the target download rate of the current network, waits for a preset time, and triggers the second judging module 33, when the video is not downloaded completely.

The downloading module 36 downloads the target video in the video list.

The playing module 37 plays a downloaded part in the target video when the video is ended or an instruction for playing the target video is received.

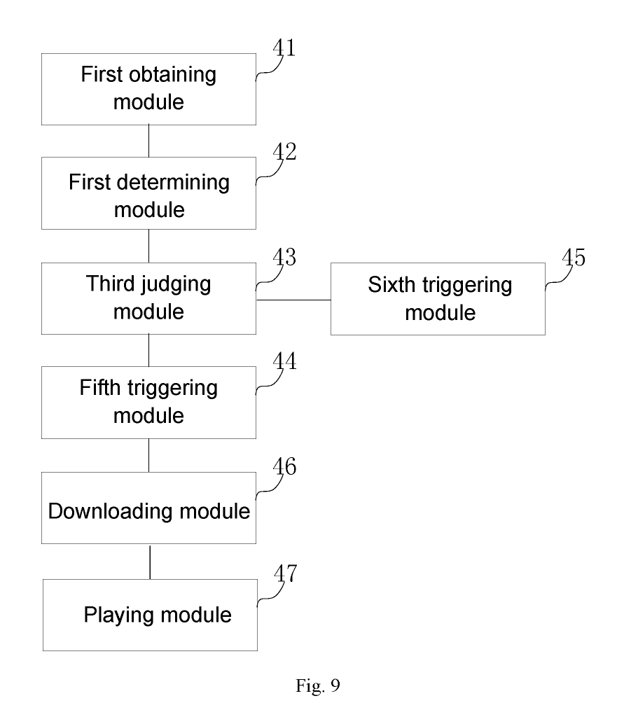

FIG. 9 is a schematic diagram illustrating yet another device for continuously playing video provided according to an embodiment of the present disclosure. Referring to FIG. 9, the device includes a first obtaining module 41, a first determining module 42, a third judging module 43, a fifth triggering module 44, a sixth triggering module 45, a downloading module 46 and a playing module 47.

The first obtaining module 41 obtains a total duration and a current playing duration of a video when the video in a video list is being played.

The first determining module 42 determines a next target video to be played in the video list when a difference between the total duration and the current playing duration is less than a first threshold value.

The third judging module 43 judges whether the video is downloaded completely.

The fifth triggering module 44 triggers the downloading module 46 when the video is downloaded completely.

The sixth triggering module 45 waits for a preset time and triggers the third judging module 43 when the video is not downloaded completely.

The downloading module 46 downloads the target video in the video list.

The playing module 47 plays a downloaded part in the target video when the video is ended or an instruction for playing the target video is received.

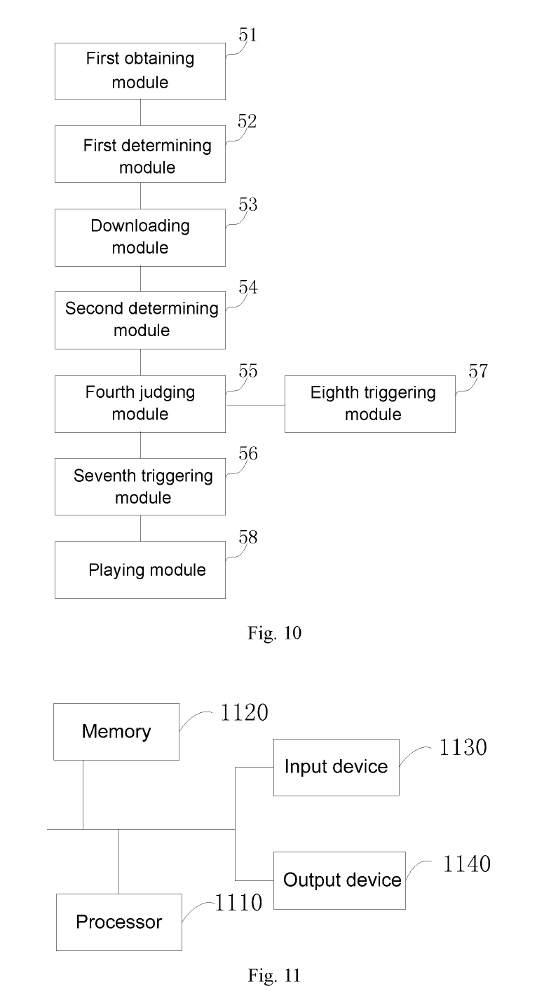

FIG. 10 is a schematic diagram illustrating yet another device for continuously playing video provided according to an embodiment of the present disclosure. Referring to FIG. 10, the device includes a first obtaining module 51, a first determining module 52, a downloading module 53, a second determining module 54, a fourth judging module 55, a seventh triggering module 56, an eighth triggering module 57 and a playing module 58.

The first obtaining module 51 obtains a total duration and a current playing duration of a video when the video in a video list is being played.

The first determining module 52 determines a next target video to be played in the video list when a difference between the total duration and the current playing duration is less than a first threshold value.

The downloading module 53 downloads the target video in the video list.

The second determining module 54 determines a total data volume of the target video.

The fourth judging module 55 judges whether a ratio between a downloaded data volume and the total data volume of the target video is larger than a third threshold value.

The seventh triggering module 56 stops downloading the target video and triggers the playing module 58 when the ratio between the downloaded data volume and the total data volume of the target video is larger than the third threshold value.

The eighth triggering module 57 waits for a preset time and triggers the fourth judging module 55 when the ratio between the downloaded data volume and the total data volume of the target video is less than or equal to the third threshold value.

The playing module 58 plays a downloaded part in the target video when the video is ended or an instruction for playing the target video is received.

In regard to the devices according to the above embodiments, the specific manners in which the respective modules thereof execute operations have been described in details in corresponding method embodiments, which will not be described in details herein.

What is described above are merely specific implementations of the present disclosure, and the protection scope of the present disclosure is not limited thereto. Various of equivalent variations or substitutions may be readily obtained by one of ordinary skilled in the art based on what is disclosed by the present disclosure, all of which should be fell into the protection scope of the present disclosure. Therefore, the protection scope of the present disclosure should be defined by the accompanying claims.

An embodiment of the present disclosure further provides another terminal, including a processor and a memory which is stored with instructions executable by the processor, wherein, the processor obtains a total duration and a current playing duration of a video when the video in a video list is being played, determines a next target video to be played in the video list when a difference between the total duration and the current playing duration is less than a first threshold value, downloads the target video in the video list, and plays a downloaded part in the target video when the video is ended or an instruction for playing the target video is received.

An embodiment of the present disclosure provides a non-volatile computer storage medium stored with computer executable instructions, which are used to perform any one of the methods for continuously playing video according to the above method embodiments.

FIG. 11 is a hardware structure diagram of an electronic device for performing a method for continuously playing video according to an embodiment of the present disclosure. As shown in FIG. 11, the device includes one or more processors 1110 and a memory 1120, and FIG. 11 illustrates one processor 1110 as an example.

The device for performing a method for continuously playing video may further include an input device 1130 and an output device 1140.

The processor 1110, memory 1120, input device 1130 and output device 1140 may be connected with each other through bus or other forms of connections. FIG. 11 illustrates bus connection as an example.

As a non-volatile computer readable storage medium, the memory 1120 may be configured to store non-volatile software program, non-volatile computer executable program and modules, such as program instructions/modules corresponding to the method for continuously playing video according to the embodiments of the present disclosure (for example, the first obtaining module, first determining module, downloading module and playing module as shown in FIGS. 6-10). By executing the non-volatile software program, instructions and modules stored in the memory 1120, the processor 1110 may perform various functional applications of a server and data processing, that is, the method for continuously playing video according to the above method embodiments.

The memory 1120 may include a program storage area and a data storage area, the program storage area may be stored with an operating system and applications which are needed by at least one functions, and the data storage area may be stored with data which is created according to use of the device for continuously playing video. Further, the memory 1120 may include a high-speed random access memory, and may further include a non-volatile memory, such as at least one of disk memory device, flash memory device or other types of non-volatile solid state memory device. In some embodiments, optionally, the memory 1120 may include a memory provided remotely from the processor 1110, and such memory may be connected with the device for continuously playing video through network connections. The examples of the network connections may include but not limited to internet, intranet, LAN (Local Area Network), mobile communication network or combinations thereof.

The input device 1130 may receive inputted digital or character information, and generate key signal input related to the user settings and functional control of the device for continuously playing video. The output device 1140 may include a display device such as a display screen.

The above one or more modules may be stored in the memory 1120, and when these modules are executed by the one or more processor 1110, the method for continuously playing video according to any one of the above method embodiments may be performed.

The above product may perform the methods provided in the embodiments of the present disclosure, and include functional modules corresponding to these methods and advantageous effects. Further technical details which are not described in detail in the present embodiment may refer to the methods provided according to embodiments of the disclosure.

The electronic device in embodiments of the present disclosure may be embodied in various forms, including but not limited to:

(1) mobile communication device, characterized in having a function of mobile communication and mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console, E-book and smart toys and portable vehicle navigation device;

(4) server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned embodiments for the device are merely illustrative, wherein the unit illustrated as a separated component may be or may not be physically separated, the component illustrated as a unit may be or may not be a physical unit, in other words, may be either disposed in a same place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to perform the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for continuously playing video, at an electronic device, comprising:
obtaining a total duration and a current playing duration of a video when the video in a video list is being played;
determining a next target video to be played in the video list when a difference between the total duration and the current playing duration is less than a first threshold value;
downloading the target video in the video list; and
playing a downloaded part in the target video when the video is ended or an instruction for playing the target video is received.

2. The method for continuously playing video according to claim 1, further comprising after the downloading the target video in the video list:
obtaining a current buffering duration of the video;
judging whether a difference between the buffering duration and the current playing duration is less than a second threshold value;
stopping downloading the target video, waiting for a preset time, re-obtaining the current playing duration of the video, and triggering the step of obtaining the current buffering duration of the video, when the difference between the buffering duration and the current playing duration is less than the second threshold value;
triggering the step of playing the downloaded part in the target video when the video is ended or the instruction for playing the target video is received, when the difference between the buffering duration and the current playing duration is larger than or equal to the second threshold value.

3. The method for continuously playing video according to claim 1, further comprising after the step of determining the next target video to be played in the video list:
judging whether the video is downloaded completely;
triggering the step of downloading the target video in the video list when the video is downloaded completely;
determining a download rate of a current network, determining a product of a preset ratio and the download rate to be a target download rate, downloading the target video using the target download rate of the current network, waiting for a preset time, and triggering the step of judging whether the video is downloaded completely, when the video is not downloaded completely.

4. The method for continuously playing video according to claim 1, further comprising after the step of determining the next target video to be played in the video list:
judging whether the video is downloaded completely;
triggering the step of downloading the target video in the video list when the video is downloaded completely;
waiting for a preset time and triggering the step of judging whether the video is downloaded completely, when the video is not downloaded completely.

5. The method for continuously playing video according to claim 1, further comprising after the step of downloading the target video in the video list:
determining a total data volume of the target video;
judging whether a ratio between a downloaded data volume and the total data volume of the target video is larger than a third threshold value;
stopping downloading the target video, and triggering the step of playing the downloaded part in the target video when the video is ended or the instruction for playing the target video is received, when the ratio between the downloaded data volume and the total data volume of the target video is larger than the third threshold value;
waiting for a preset time, and triggering the step of judging whether the ratio between the downloaded data volume and the total data volume of the target video is larger than the third threshold value, when the ratio between the downloaded data volume and the total data volume of the target video is less than or equal to the third threshold value.

6. A non-volatile computer-readable storage medium, which is stored with computer executable instructions that, when executed by an electronic device, cause the electronic device to:
obtain a total duration and a current playing duration of a video when the video in a video list is being played;
determine a next target video to be played in the video list when a difference between the total duration and the current playing duration is less than a first threshold value;
download the target video in the video list; and
play a downloaded part in the target video when the video is ended or an instruction for playing the target video is received.

7. The non-volatile computer-readable storage medium according to claim 6, wherein, the execution of the computer executable instructions further causes the electronic device to, after the downloading the target video in the video list:
obtain a current buffering duration of the video;
judge whether a difference between the buffering duration and the current playing duration is less than a second threshold value;
stop downloading the target video, wait for a preset time, re-obtain the current playing duration of the video, and trigger the step of obtaining the current buffering duration of the video, when the difference between the buffering duration and the current playing duration is less than the second threshold value;
trigger the step of playing the downloaded part in the target video when the video is ended or the instruction for playing the target video is received, when the difference between the buffering duration and the current playing duration is larger than or equal to the second threshold value.

8. The non-volatile computer-readable storage medium according to claim 6, wherein, the execution of the computer executable instructions further causes the electronic device to, after the step of determining the next target video to be played in the video list:
judge whether the video is downloaded completely;
trigger the step of downloading the target video in the video list when the video is downloaded completely;
determine a download rate of a current network, determine a product of a preset ratio and the download rate to be a target download rate, download the target video using the target download rate of the current network, wait for a preset time, and trigger the step of judging whether the video is downloaded completely, when the video is not downloaded completely.

9. The non-volatile computer-readable storage medium according to claim 6, wherein, the execution of the computer executable instructions further causes the electronic device to, after the step of determining the next target video to be played in the video list:
judge whether the video is downloaded completely;
trigger the step of downloading the target video in the video list when the video is downloaded completely;
wait for a preset time and trigger the step of judging whether the video is downloaded completely, when the video is not downloaded completely.

10. The non-volatile computer-readable storage medium according to claim 6, wherein, the execution of the computer executable instructions further causes the electronic device to, after the step of downloading the target video in the video list:
determine a total data volume of the target video;
judge whether a ratio between a downloaded data volume and the total data volume of the target video is larger than a third threshold value;
stop downloading the target video, and trigger the step of playing the downloaded part in the target video when the video is ended or the instruction for playing the target video is received, when the ratio between the downloaded data volume and the total data volume of the target video is larger than the third threshold value;
wait for a preset time, and trigger the step of judging whether the ratio between the downloaded data volume and the total data volume of the target video is larger than the third threshold value, when the ratio between the downloaded data volume and the total data volume of the target video is less than or equal to the third threshold value.

11. An electronic device, comprising:
at least one processor; and
a memory, communicably connected with the at least one processor and storing instructions executable by the at least one processor,
wherein execution of the instructions by the at least one processor causes the at least one processor to:
obtain a total duration and a current playing duration of a video when the video in a video list is being played;
determine a next target video to be played in the video list when a difference between the total duration and the current playing duration is less than a first threshold value;
download the target video in the video list; and
play a downloaded part in the target video when the video is ended or an instruction for playing the target video is received.

12. The electronic device according to claim 11, wherein, the execution of the instructions by the at least one processor further causes the at least one processor to, after the downloading the target video in the video list:
obtain a current buffering duration of the video;
judge whether a difference between the buffering duration and the current playing duration is less than a second threshold value;
stop downloading the target video, wait for a preset time, re-obtain the current playing duration of the video, and trigger the step of obtaining the current buffering duration of the video, when the difference between the buffering duration and the current playing duration is less than the second threshold value;
trigger the step of playing the downloaded part in the target video when the video is ended or the instruction for playing the target video is received, when the difference between the buffering duration and the current playing duration is larger than or equal to the second threshold value.

13. The electronic device according to claim 11, wherein, the execution of the instructions by the at least one processor further causes the at least one processor to, after the step of determining the next target video to be played in the video list:
judge whether the video is downloaded completely;
trigger the step of downloading the target video in the video list when the video is downloaded completely;
determine a download rate of a current network, determine a product of a preset ratio and the download rate to be a target download rate, download the target video using the target download rate of the current network, wait for a preset time, and trigger the step of judging whether the video is downloaded completely, when the video is not downloaded completely.

14. The electronic device according to claim 11, wherein, the execution of the instructions by the at least one processor further causes the at least one processor to, after the step of determining the next target video to be played in the video list:
judge whether the video is downloaded completely;
trigger the step of downloading the target video in the video list when the video is downloaded completely;
wait for a preset time and trigger the step of judging whether the video is downloaded completely, when the video is not downloaded completely.

15. The electronic device according to claim 11, wherein, the execution of the instructions by the at least one processor further causes the at least one processor to, after the step of downloading the target video in the video list:
determine a total data volume of the target video;
judge whether a ratio between a downloaded data volume and the total data volume of the target video is larger than a third threshold value;
stop downloading the target video, and trigger the step of playing the downloaded part in the target video when the video is ended or the instruction for playing the target video is received, when the ratio between the downloaded data volume and the total data volume of the target video is larger than the third threshold value;
wait for a preset time, and trigger the step of judging whether the ratio between the downloaded data volume and the total data volume of the target video is larger than the third threshold value, when the ratio between the downloaded data volume and the total data volume of the target video is less than or equal to the third threshold value.
